(19) United States
(12) Patent Application Publication
(10) Pub. No.: US 2003/0053662 A1
(43) Pub. Date: Mar. 20, 2003

(54) Method and apparatus for digital encoding and operator identification using stored user image

(75) Inventors: David R. Evoy, Tempe, AZ (US); Thierry Brouste, Nogent Sur Marne (FR); Jean Gobert, Maisons-Alfort (FR)

Correspondence Address: Crawford PLLC, Suite 390, 1270 Northland Drive, St. Paul, MN, 55120, US

(73) Assignee: Koninklijke Philips Electronics N.V.

(21) Appl. No.: 09/955,809

(22) Filed: Sep. 19, 2001

(51) Int. Cl. G06K 9/00

(52) U.S. Cl. 382/115

(57) ABSTRACT

A security method uses a single stored object as both an MPEG4 object for video compression, and for user identification and security. An authorized user video image is digitized to create corresponding authorized user identity data, which is stored as pixel data. A method is provided using the authorized user video image as a reference image for compression techniques. A stored image difference threshold level, defines the required degree of image match necessary. A present user video image is received, and digitized to create corresponding present user identity data. Image differences, between the present user video image and the authorized user video image are determined and compared to the image difference threshold level to determine whether to permit device usage. In one embodiment, video images are stored in MPEG4 format. The protected device is disabled when differences between a present user video image and an authorized user video image exceed threshold level. Alternate user authorization is optionally requested if image authentication fails. A present user video image is optionally stored or transmitted to a monitoring station if video authentication fails. Motion in present user video image is optionally detected as a prerequisite to authentication. An apparatus for carrying out the video security and compression methods is provided.

### FIELD OF THE INVENTION

The present invention generally relates to video device security and, more particularly, to a method and apparatus for encoding a video image and identifying an operator.

### BACKGROUND OF THE INVENTION

Theft or misuse of electronic devices is a major problem for owners of many types of electronic equipment including but not limited to cell phones, video-conference equipment, and PDA's. Security is an important aspect in most of such equipment and typically the responsibility of the owner. Conventional means for achieving device security include surveilling an area within which the device is located, maintaining physical control of the device, device locking mechanisms, and requiring entry of an alpha-numeric password as a prerequisite to using the device. Each of the above-mentioned approaches has certain weaknesses.

Area surveillance employs security cameras to continuously, or periodically, record video or still images of the area of interest. In some instances, a triggering event, such as motion detection or body heat, initiates recording. While area surveillance is helpful in identifying thieves and unauthorized users, thus deterring them, human intervention is required to monitor, evaluate and identify images of interest. Real-time human intervention is expensive and can be imprecise.

Continuously maintaining physical custody of an electronic device is not always possible, particularly devices intended to serve multiple users. Electronic device locking mechanisms and features that disable use pending password authorization are typically clumsy and inconvenient. Frequently, for convenience, users elect not to utilize security means that require repetitive and active user implementation.

For a variety of reasons including those discussed herein, it will be appreciated that there is a need for a method and apparatus for conveniently securing an electronic video device. A method and apparatus for encoding a digital video image and identifying an operator that address the aforementioned problems, as well as other related problems, are therefore desirable.

### SUMMARY OF THE INVENTION

The present invention is directed to a device security approach that verifies an authorized user in a manner that addresses the above-mentioned challenges. The present invention is exemplified in a number of implementations and applications, some of which are summarized below.

According to an example embodiment of the present invention, a device security method verifies an authorized user by comparing a present user video image to a stored authorized user video image. The method includes storing an authorized user video image corresponding to authorized user identity data and, after receiving a present user video image corresponding to user identity data, determining image differences between the present user video image and the authorized user video image. Based on the image differences and an image-difference threshold level, user authorization is permitted, for example, by enabling operation of the device when the quantity of image differences do not exceed the difference threshold level. Other example embodiments of the present invention are directed to methods and devices employing the above method as well as variations thereof.

Other aspects of the invention are directed to devices and variations of the particular approach characterized above. Thus the above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a flow chart of an example embodiment of a device security method in accordance with the present invention;

FIG. 2 is a block diagram of an example embodiment of a video security apparatus in accordance with the present invention;

FIG. 3 is a block diagram of one example embodiment of a video coding apparatus, useful, e.g. in the apparatus of FIG. 2, and also in accordance with the present invention;

FIG. 4 is a flow chart of an example embodiment an interframe coding method in accordance with the present invention;

FIG. 5 is a block diagram of one example embodiment of a video coding apparatus in accordance with the present invention; and

FIG. 6 is a block diagram of one example embodiment of a video decoding apparatus in accordance with the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

A security method and apparatus for verifying an authorized device-user is provided for devices which can benefit from improved passive security measures, including but not limited to, cellular telephones, videophones, video conferencing equipment, vehicles and passageways. In the particular embodiment, the invention uses a single stored MPEG4 object both for video compression, and for user identification and security. An authorized user video image is input via a video image input device and digitized to create a digital representation of the user video image corresponding authorized user identity data. Authorized user identity data is stored in a user video reference image memory as a user video reference image. A user video reference image controller controls access to the user video reference image memory. An image difference threshold level, defining the degree of image matching necessary is defined and stored. When a present user video image is received, it is digitized to create corresponding present user identity data. Present user video image motion is optionally confirmed as a prerequisite to user authentication. A comparator determines difference information between the user video reference image and a present user video image. Image differences are further compared, in an authentication device, to an image difference threshold level. In response to the determination of image differences, and comparison of the images differences to the difference threshold level, a determination whether to permit device usage is made. An output is provided to communicate an identity mismatch, such as by disabling the image input device, disabling the protected device, or communicating the present user video image to a monitoring station.

User identity images are captured as digital data. In the above-mentioned particular embodiment, video images are stored in MPEG4 format. The image difference threshold level is defined as a quantity representative of the quantity and magnitude of digital pixel data differences. When the quantity and magnitude of digital pixel data differences exceeds the stored image difference threshold level quantity, device use is not permitted alternate user authorization is also optionally requested, and the present user video image is optionally stored or transmitted to a monitoring station. An apparatus for inputting and digitizing authorized and present user video images is further provided, along with controls for comparing and authenticating user video images to a reference video image and an output for communicating a mismatch. Once device security is verified, the authorized user video image is used as a reference image for compressing video signals.

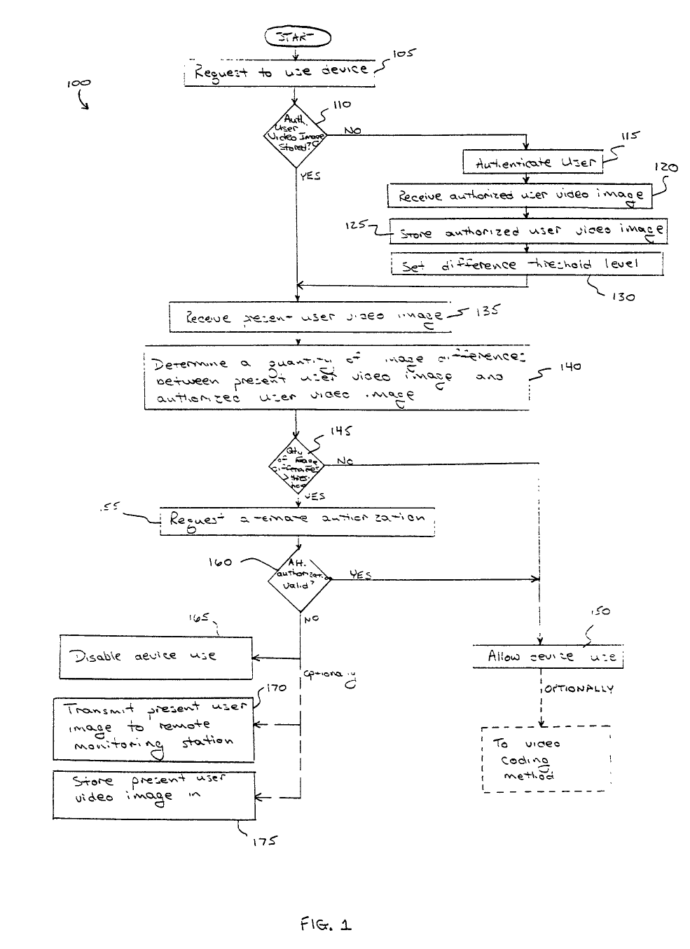

FIG. 1 illustrates an example embodiment of a device security method depicted as flow 100, in accordance with the present invention. The security method is implemented in association with a device to be secured. An authorized user is a designated person or entity with permission to use the protected device, the device owner or custodian for example. A present user is a person or entity attempting to use the device. A present user may or may not be an authorized user. In one embodiment, the device being secured captures a user video image via a video input portion. In one embodiment, the user video image is framed to include a head and face of a user, but a user video image is not so limited within the spirit of the present invention and may optionally include more or fewer user-identifying features. Devices obviously capable of capturing a user video image include a cellular phone, videophone, or video conferencing equipment.

Upon a request by a present user to use the device (block 105), or to initiate the security features of the device, a determination is made whether at least one authorized user video image has been stored in the device (block 110). If no authorized user video image is stored, a user is authenticated (block 115) to confirm an image to be stored is that of an authorized user. For example, entry of a password, or remote confirmation of an image can be required to store user video images as authorized users video images. Once authenticated, an authorized user video image is received (block 120) and stored (block 125) in the device. In one example embodiment of the present invention, the authorized user video image is received and stored digitally as pixel data into a first memory, corresponding to authorized user identity data. In a further example embodiment, the authorized user video image is stored as an MPEG4 object. For example in a cellular telephone, an image of an authorized cellular telephone user is stored to insure that calls are only placed by authorized individuals. More than one authorized user image can be stored, in a library of authorized user video images for example, to accommodate multiple device users. Different poses of an authorized user can be stored, for example an image of the authorized user wearing glasses, and one image without the glasses.

A difference threshold level is set (block 130) to define the level of image matching required in determining whether a present user is an authorized user. In one example embodiment, the difference threshold is a quantitative representation of the magnitude or quantity of digital image differences allowed between a present user video image and a stored authorized user video image. Image differences are determined, for example, by pixel comparisons where a pixel at one location of one image is compared against a pixel at the similar location in another image. Determining difference information between two digital images and the difference threshold level is defined and set in terms of the particular comparison method implemented as is conventional. For example, a pixel by pixel comparison of two digital images can simply count the number of pixels in a field that are identical, or inversely, non-identical. The difference threshold level is defined then, in terms of an absolute quantity of pixel comparisons, or alternatively, as a percentage of pixel comparisons.

The authorized user video image and the present user video image are captured by an identical device (e.g., a video input portion of the protected device); therefore, field and composition of the images are similar. An authorized user video image should be similar to a present user video image, but perhaps not identical due to slight variations in the user's appearance such as hair length, expression, clothing, or make-up. Environmental or equipment difference may also introduce some variation between a stored authorized user video image and a present user video image of the same individual, such as light conditions, video input angle or distance to subject. Therefore the receiving terminal includes a processing block (e.g., adapted software) to accommodate some video image difference is desirable. The processor quantitatively compares a known authorized user digital video image to an unknown present user digital video image to measure differences, and subsequently, compares the measured differences to a threshold defining the boundary between an acceptable level of difference and an unacceptable level of difference. If the threshold is too constraining, authorized users are not recognized. If the threshold is not sufficiently constraining, unauthorized users are not rejected. A selectable difference threshold level allows some range to define an appropriate balance point between convenience and security.

In a further embodiment, difference threshold level is defined to incorporate measurement of pixel information difference magnitude, not just a quantity of similar or dissimilar pixels. Digital pixel information isn't restricted to binary states, and often includes shade or color information, which is quantified as a pixel value. Therefore, the magnitude of pixel value differences (i.e., the quantitative representation of the variation in color between pixels similarly located in each image) is summed to establish a quantitative measure of image differences. Therefore, the difference threshold level is defined to reflect a sum of pixel information magnitude differences. A default difference threshold level is provided in one embodiment. While an embodiment having a selectable difference threshold level is set forth above, an embodiment having a fixed difference threshold level is within the spirit of the invention.

Once a difference threshold level is set and at least one authorized user video image is stored, a present user video image is received (block 135) corresponding to user identity data. The present user video image is received via the same video input portion as the authorized user video images. The present user video image is optionally stored. In one example embodiment, the present user video image is received and stored digitally, corresponding to present user identity data, as pixel data into a second memory. In a further example embodiment, the present user video image is stored as an MPEG4 object. In one embodiment, the present user video image is only temporarily stored in a memory, but in a further embodiment, the present user video image is stored indefinitely, for example in a present user video log.

The present user video image is compared to a stored, authorized video image to determine image differences (block 140) between the present user video image and the authorized user video images. In a further embodiment of the present invention, authorized and present user video images are scaled to the same proportions prior to comparing images. When more than one authorized user video image is stored, the present user video image is compared to each of the authorized user video images to determine image differences.

In one example embodiment, the present user video image is checked for motion before capturing a present user video image for comparison to authorized user video images. In another embodiment, motion is verified subsequent to receiving a present user video image to be used for authorization determinations. Motion detection is optionally used to insure that a photo of an authorized user is not substituted for a live present user in an effort to defeat the video security measures described herein. Motion of interest includes movement of the lips or flicker of the eyes. Motion is detected as differences between two or more present user video images in a fashion similar to the comparisons described herein to determine differences between a present user video image and an authorized user video image. For example, differences between present user video images are determined and compared to a minimum difference threshold. Sufficient difference between time-separated present user images is indicative of movement of the present user. Some threshold of difference between the present user video images is required. Movement detection can be limited to mouth, eye or other portions of the present user video image. In a further embodiment, the differences between present user video images must not exceed some maximum level of differences. Motion detection difference thresholds are optionally selectable, but can be fixed in another embodiment of the present invention. Motion detection difference thresholds are defined to be compatible with a particular difference determination methodology employed, such as a quantity of pixels with differences, or optionally, a quantity representative of a magnitude of pixel information differences.

Once differences are determined between the present user identity data and an authorized user identity data, block 145 depicts a determination being made whether the differences exceeds a difference threshold level. From comparison of actual differences to a threshold limit, a determination whether to permit device use is made. If the difference between the present user video image and an authorized user video image do not exceed the difference threshold level (i.e., the present user video image matches an authorized user video image within an acceptable degree of error), device use is allowed as depicted at block 150. If image differences exceed the threshold, alternate authorization is requested by the device (block 155).

Alternate authorization is implemented in various methods, including conventionally-known methods. Alternate authorization can include, but is not limited to, repeating a present user video image authentication as described above, or entry of an alpha-numeric password, or voice recognition, or operation of a key device. As shown at block 160, the alternate authorization is validated 160 by means appropriate to the type of alternate authorization employed. If the alternate authorization is valid, device use is allowed. If the alternate authorization is likewise not valid (i.e., the present user is not an authorized user), the device is disabled from use as depicted at block 165. Optionally, if the alternate authorization is not valid, the present user video image is transmitted to a remote monitoring station (block 170) for identification of an unauthorized present user attempting to use the device, and/or stored in an unauthorized user log at block 175. The unauthorized user log is located within the protected device for later retrieval, or alternately, is located at the remote monitoring station. Transmitted images of non-authorized users can deter attempted use of the device and aid in recovery of the device if missing.

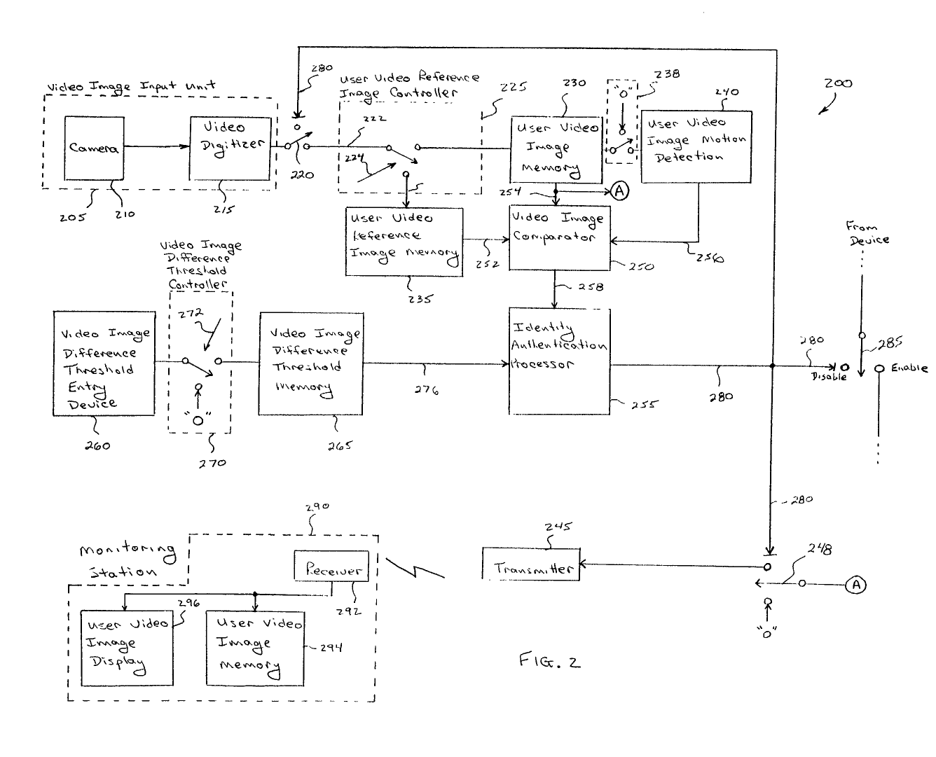

FIG. 2 is a block diagram of one example embodiment of a video device security apparatus 200 in accordance with the present invention. A video image input unit 205 comprises a camera 210 coupled to a video digitizer 215. Video image input unit 205 creates a digital representation of the user video image and produces a user video image signal 222. Alternatively, video image input unit is a digital camera. Video image input unit is coupled to video input switch 220. Video input switch is coupled to user video reference image controller 225, which is farther coupled to user video image memory 230 and user video reference image memory 235. User video reference image controller receives the digital user video image signal 222 from video image input unit 205 and, in response to a “store-image” control signal 224, directs digital user video image signal 222 to one of either user video image memory 230 or user video image reference memory 235.

User video image memory 230 is coupled to user video image motion detection 240 through motion detection enable switch 238. Motion detection is optionally selectable via enable switch 238. User video image memory 230 is further coupled to transmitter 245, through transmitter enable switch 248. User video image memory 230 is also coupled to video image comparator 250. Comparator 250 receives a user video reference image signal 252 and a present user video image signal 254, along with a motion detection flag 256. Comparator 250 determines difference information between the user video reference image signal 252 and the present user video image signal 254 when (a) motion detection is not enabled, or (b) motion detection is enabled and detected. Video image comparator 250 is coupled to identity authentication processor 255 and provides an image difference signal 258 thereto.

A video image difference threshold is entered via video image difference threshold entry device 260. Video image difference threshold entry device 260 is coupled to video image difference threshold memory 265 through a video image difference threshold controller 270. Controller 270 controls access to difference threshold memory 265 in response to a security control signal 272 which allows access (i.e., ability to store or change difference threshold setting stored in memory) only to authorized users. Video image difference threshold memory 265 is coupled to identity authentication processor 255. Identity authentication processor 255 compares image difference signal 258 with an image difference threshold signal 276 and determines whether device usage is permitted. Identity authentication processor produces a device permit signal 280.

Identity authentication processor is coupled to device enable switch 285, video input switch 220, and transmitter enable switch 248, each of which is responsive to device permit signal 280. Device enable switch 285 enables or disables function of the protected device responsive to device permit signal 280. Video input switch disables input of video image signal 222, and thus use of video image signal 222 by the protected device responsive to device permit signal 280. Transmitter enable switch 248 directs present user video image signal 254 to transmitter 245 for communication to a monitoring station 290 responsive to device permit signal 280. Monitoring station 290 comprises a receiver 292 for receiving present user video image signal 254. Receiver 292 is coupled to a user video image memory 294 for storing present user video image signal. Receiver 292 is also coupled to a user video image display 296 for displaying present user video image signal 254.

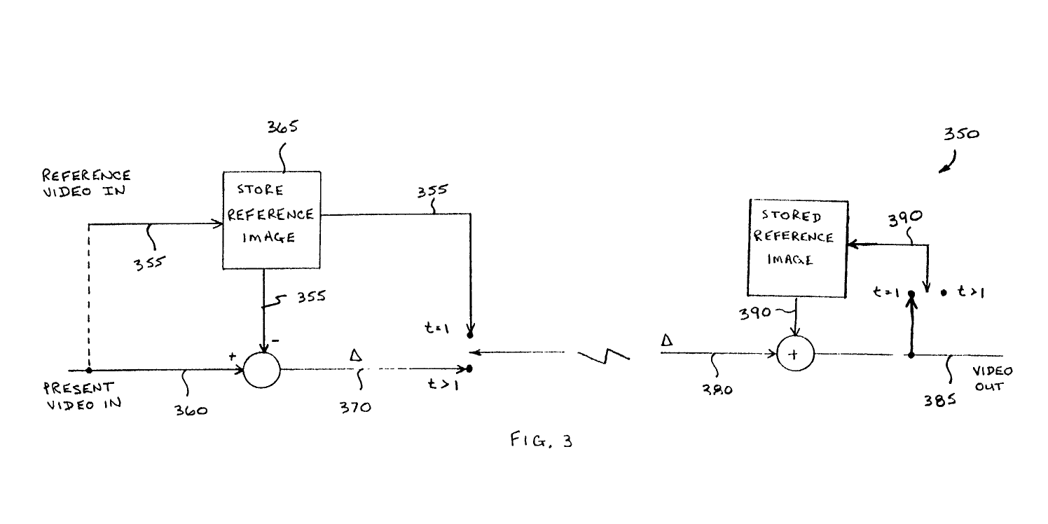

A block diagram of an encoding method of the present invention is shown in FIG. 3. A reference video image (frame) 355 is stored in a memory 365. In one example embodiment, the reference video image is stored digitally. In a further example embodiment, the reference video image is stored as a MPEG4 object. The reference video image 355 need not be developed in real time, but rather when a new (authorized) user is added and an authorized user video image is created and stored, for example. Initially (i.e., t=1), the reference video image 355 is directed to and caused to be transmitted. Subsequently (t>1), a present video image 360 is received and compared to the reference video image 355 to determine difference information 370, which is directed to and caused to be transmitted. The reference video image 365 is not further updated during the transmission, and each present video image 360, in most applications, is always compared to the static reference video image 355. The encoding process continues in a continuous cycle.

At the receiver end of the present invention, the process is reversed. Video images (frames) 380 are received. A first (t=1) video image (the reference video image) is received in its entirety, output as a video output image 385, and stored to serve as a reference video image (frame) 390. Subsequently (t>1), only video image (frame) difference information is received for each frame, which is added to the stored reference video image (frame) 390 to reconstruct a video output image 385. The stored reference video image 390 is not further updated. The reconstruction process continues in a continuous cycle.

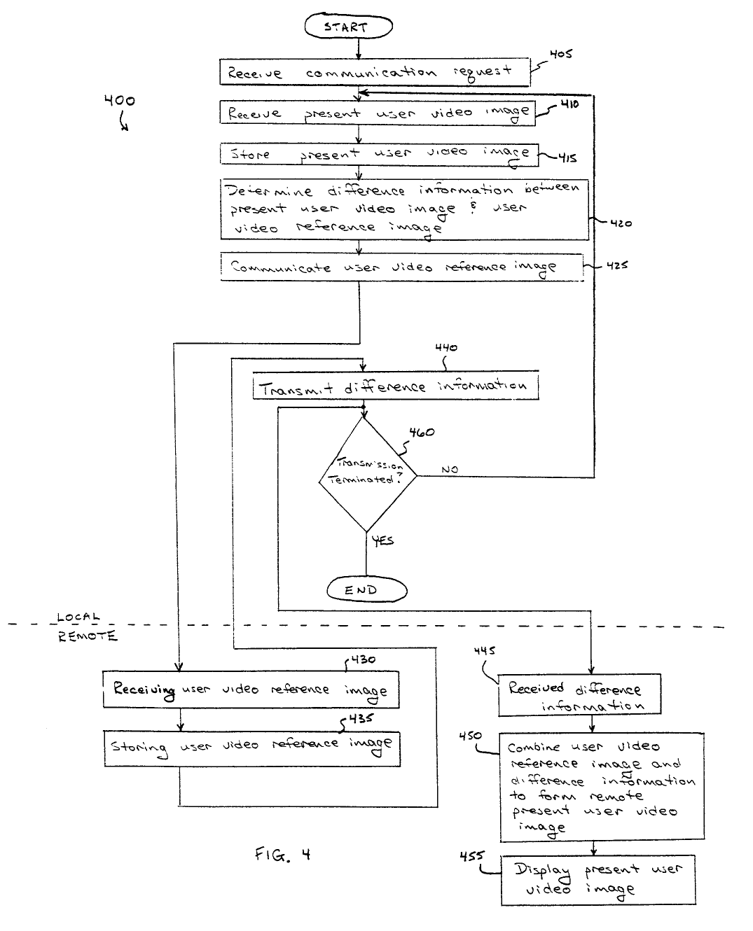

Referring now to FIG. 4, a video compression method 400 is provided. A user reference video image is previously received and stored. In one example embodiment, an authorized user video image stored as part of a device video security method, is used as the user reference video image. In addition to device security, the user reference video image is used to facilitate efficient video encoding. Upon a receipt of a video communication request 405, a present user video image is received 410 and stored 415 in a memory. In one example embodiment, the present user video image and the user reference video image are stored digitally. In a further example embodiment, the present user video image and user reference video image are stored as MPEG4 objects. Present user video images, also known as frames, are created by periodically sampling a video input signal to “freeze” a still video frame. Difference information is determined 420 between the present user video image and the user reference video image. In a further embodiment, difference information is determined only for selected portions between the present user and user reference video images, for example a mouth region portion and/or eye region portion.

The user reference video image is communicated 425 to a remote location. The user reference video image is received 430 and stored 435 in a memory. Subsequently, difference information between present user video image and the reference video image is transmitted 440, received 445 at the remote location, combined with the user video reference image to form remote present user video image 450, and displayed 455. The process continues in a continuous cycle until a decision to terminate transmission 460 occurs.

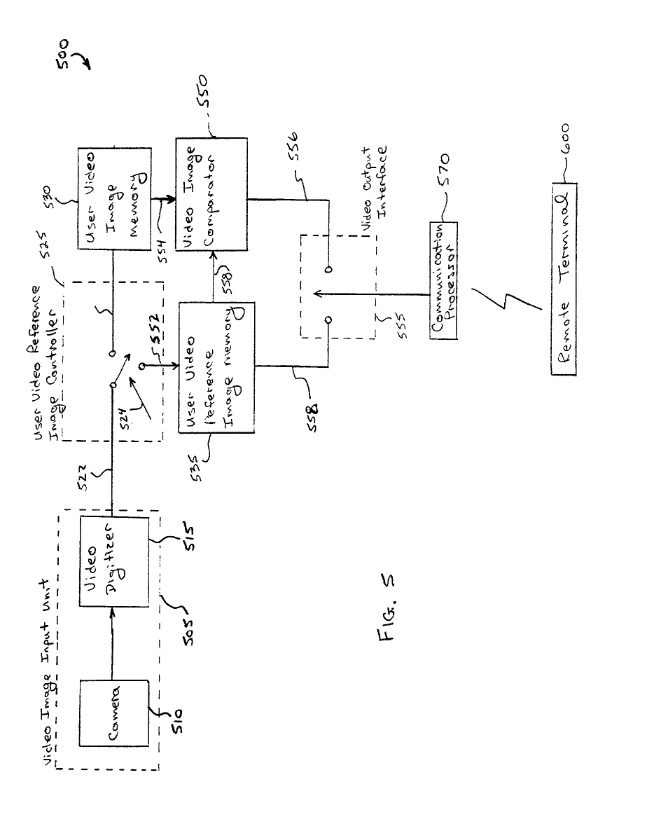

FIG. 5 is a block diagram of one example embodiment of the video encoding apparatus 500 in accordance with the present invention. A video image input unit 505 comprises a camera 510 coupled to a video digitizer 515. Video image input unit 505 creates a digital representation of the user video image and produces a user video image signal 522. Alternatively, video image input unit 505 is a digital camera. Video image input unit 505 is coupled to user video reference image controller 525, which is further coupled to user video image memory 530 and user video reference image memory 535. User video reference image controller 525 receives digital image signal 522 from video image input unit 505. In response to a “store-image” control signal 524, controller 525 directs digital image signal 522 to either user video image memory 530 or user video image reference memory 535.

User video image memory 530 is coupled to user video image comparator 550. Comparator 550 receives a user video reference image signal 552 and a present image signal 554. Comparator 550 determines an image difference information signal 556 from stored user video reference image signal 558 and present user image signal 554. Video image comparator 550 is coupled to video output interface 555 and provides image difference information signal 556 thereto. User video reference image memory 535 is also coupled to video output interface 555, and provides a stored user video reference image signal 558 thereto. Video output interface 555 initially directs stored user video reference image signal 558 to communication processor 570 for transmission to remote terminal 600. Subsequently, video output interface 555 directs image difference information signal 556 to communication processor 570 for transmission to remote terminal 600.

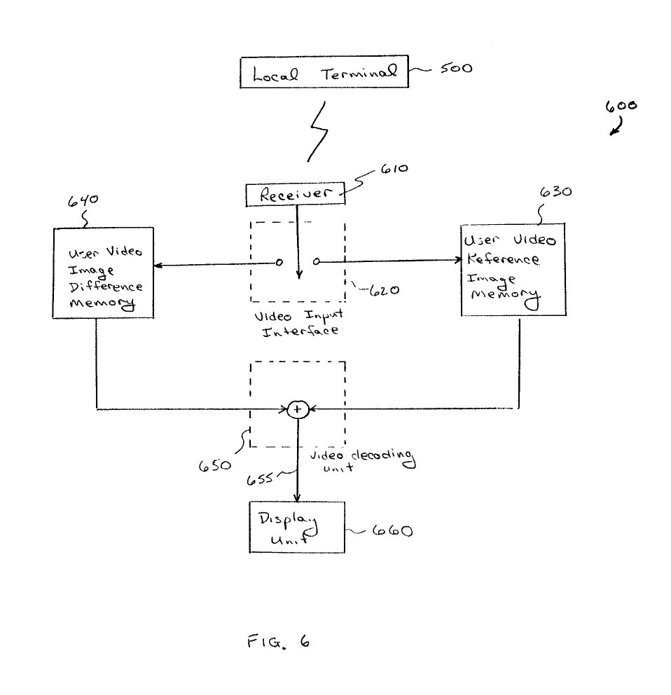

FIG. 6 is a block diagram of one example embodiment of the video decoding apparatus at remote terminal 600 in accordance with the present invention. A receiver 610 is coupled to user video reference image memory 630 and user video image difference memory 640 through video input interface 620. User video reference image memory 630 and user video image difference memory 640 are each coupled to video decoding unit 650. Video decoding unit 650 is coupled to display unit 660.

Receiver 610 initially receives a user reference image signal, which is directed by video input interface 620 to user video reference image memory 630 for storage. Receiver 610 subsequently receives multiple difference information signals (frames), which are each successively directed by video input interface 620 to user video image difference memory 640. Video decoding unit 650 receives and combines each successive difference information signal (frame) with the user video reference image signal to form an output video image 655, which is displayed on display unit 660.

Accordingly, the present invention is not to be necessarily limited to the particular examples described above, but is intended to cover all aspects of the invention as fairly set out in the attached claims. For instance, while a video recognition security method and apparatus are illustrated to secure a video communication device, other applications not previously incorporating video input can benefit from the above-mentioned teachings. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. A device security method for verifying an authorized user, comprising:
storing an authorized user video image corresponding to authorized user identity data;
receiving a present user video image corresponding to user identity data;
determining image differences between the present user video image and the authorized user video image; and
in response to the determination of image differences and to a difference threshold level, determining whether to permit device usage.

2. The security method of claim 1, further comprising determining a quantity of the image differences between the present user video image and the authorized user video image, and disabling the device if the quantity of image differences exceeds the difference threshold level.

3. The security method of claim 1, wherein the authorized user video image is stored as first digital pixel data into a first memory, and wherein the present user video image is stored as second digital pixel data into a second memory, and wherein the quantity of image differences are determined quantitatively between the first and second digital pixel data.

4. The security method of claim 1, wherein the present user video image and the authorized user video image are each stored in MPEG4 format.

5. The security method of claim 1, wherein the authorized and present user video images are each framed to include only the head and face portions of the user.

6. The security method of claim 1, wherein the authorized and present user video images are scaled to the same proportions.

7. The security method of claim 1, wherein the device selected from the group of cellular telephone, videophone, video conferencing equipment, vehicle, and passageway.

8. The security method of claim 1, further comprising storing the present user video image in a present user video image log.

9. The security method of claim 1, further comprising transmitting the present user video image to a monitoring station if the differences exceed the difference threshold level.

10. The security method of claim 1, further comprising requesting alternate authorization if the differences exceed the difference threshold level.

11. The security method of claim 1, further comprising confirming motion within the present user video image before determining quantity of image differences.

12. A video security apparatus, comprising:
a video image input means for producing a user video image;
a user video image digitizing means for creating a digital representation of the user video image;
a user video reference image memory for storing at least one digital user video image as a user video reference image;
a user video reference image control means for controlling access to the user video reference image memory;
a comparison means for determining difference information between the user video reference image and the user video image;
an authentication means for determining an identity mismatch from the difference information; and
an output for communicating the identity mismatch.

13. The video security apparatus of claim 12, wherein the output communicates the identity mismatch by transmitting the user video image to a monitoring station

14. The video security apparatus of claim 12, wherein the output communicates the identity mismatch by disabling the image input means.

16. An interframe coding method for performing predictive coding using a stored authorized user video image corresponding to authorized user identity data, comprising:
receiving a present user video image corresponding to user identity data;
communicating the authorized user video image to a remote video image receiver;
storing the authorized user video image at the remote video image receiver;
determining image difference information between the present user video image and the authorized user video image;
transmitting the difference information to the remote video image receiver;
combining the authorized user video image and the difference information to form an output user video image at the remote video image receiver; and
displaying the output user video image.

17. The coding method of claim 16, wherein the present user video image and the authorized user video image are each framed to include only the head and face portions of the user.

18. The coding method of claim 17, wherein the image difference information is determined only for selected portions of the authorized and present user video images.

19. The coding method of claim 18, wherein the selected portions include a mouth region and an eyes region of the authorized and present user video images.

20. The coding method of claim 16, wherein the authorized identity data and the user identity data are MPEG4 objects.
